(19) United States
(12) Patent Application Publication
(10) Pub. No.: US 2022/0404489 A1
(43) Pub. Date: Dec. 22, 2022

(54) VEHICLE LAMP, RADAR, AND VEHICLE

(71) Applicant: KOITO MANUFACTURING CO., LTD., Tokyo (JP)

(72) Inventor: Kosei Kikuchi, Shizuoka (JP)

(73) Assignee: KOITO MANUFACTURING CO., LTD., Tokyo (JP)

(21) Appl. No.: 17/776,807

(22) PCT Filed: Oct. 16, 2020
(86) PCT No.: PCT/JP2020/039139

§ 371 Date: May 13, 2022

(30) Foreign Application Priority Data
Nov. 14, 2019 (JP) 2019-206319

(51) Int. Cl. G01S 13/931; G01S 7/02; B60Q 1/00

(52) U.S. Cl. CPC G01S 13/931; G01S 7/027; B60Q 1/0023; B60Q 1/0029; G01S 2013/93277

(57) ABSTRACT

A vehicle lamp mounted on a vehicle includes: a lamp housing; a lamp cover that covers an opening of the lamp housing; at least one illumination unit disposed in a lamp chamber formed by the lamp housing and the lamp cover; a radar disposed in the lamp chamber and configured to acquire radar data indicating a surrounding environment of the vehicle by emitting a radio wave to an outside of the vehicle; and a dielectric lens disposed in front of the radar and configured to allow the radio wave emitted from the radar to pass therethrough. The dielectric lens is configured to narrow a spread angle of the radio wave emitted from the radar.

### TECHNICAL FIELD

The present disclosure relates to a vehicle lamp, a radar, and a vehicle.

### BACKGROUND ART

According to autonomous driving technology, traveling of a vehicle is controlled based on data indicating a surrounding environment of the vehicle acquired by a plurality of sensors mounted on the vehicle. As the plurality of sensors mounted on the vehicle, a camera, a laser radar, a millimeter wave radar (or a microwave radar), and the like are adopted. For example, Patent Literature 1 discloses a vehicle lamp mounted with a radar, such as a millimeter wave radar configured to acquire data indicating a surrounding environment outside a vehicle.

### CITATION LIST

### Patent Literature

Patent Literature 1: JP-A-2008-186741

### SUMMARY OF INVENTION

### Technical Problem

In an antenna portion (a transmission antenna and a reception antenna) of a radar, a plurality of antenna elements (for example, patch antennas) are arranged in a vertical direction in order to improve directivity of radio waves in the vertical direction. On the other hand, if a large number of antenna elements are arranged in the vertical direction in order to improve the directivity of radio waves in the vertical direction, a size of the antenna portion is increased, and thus a size of the entire radar is increased. As a result, a degree of freedom in design of a vehicle lamp on which the radar is mounted is reduced. Further, since the radio wave emitted from the radar spreads 180 degrees in a horizontal direction, a reflected radio wave reflected by an object existing outside a field of view (FOV) in the horizontal direction of the radar may adversely affect radar data. From the above viewpoint, there is room for improvement in the vehicle lamp on which the radar is mounted.

An object of the present disclosure is to improve a degree of freedom in design of a vehicle lamp on which a radar is mounted, and to improve reliability of radar data acquired by the radar.

### Solution to Problem

A vehicle lamp according to a first aspect of the present disclosure is mounted on a vehicle, and includes:

a lamp housing;

a lamp cover that covers an opening of the lamp housing;

at least one illumination unit disposed in a lamp chamber formed by the lamp housing and the lamp cover;

a radar disposed in the lamp chamber and configured to acquire radar data indicating a surrounding environment of the vehicle by emitting a radio wave to an outside of the vehicle; and

a dielectric lens disposed in front of the radar and configured to allow the radio wave emitted from the radar to pass therethrough.

The dielectric lens is configured to narrow a spread angle of the radio wave emitted from the radar.

According to the above configuration, spread angles in a horizontal direction and a vertical direction of the radio wave emitted from the radar can be narrowed by the dielectric lens disposed in front of the radar.

In this way, since the spread angle in the vertical direction of the radio wave is narrowed by the dielectric lens, it is possible to reduce the number of antenna elements arranged in the vertical direction. Therefore, it is possible to reduce a size of the radar, and thus it is possible to improve a degree of freedom in design of the vehicle lamp on which the radar is mounted.

In addition, since the spread angle in the horizontal direction of the radio wave is narrowed by the dielectric lens, for example, the radar data is suitably prevented from being adversely affected by a reflected radio wave reflected by an object existing outside a field of view in the horizontal direction of the radar.

In this way, the degree of freedom in design of the vehicle lamp on which the radar is mounted can be improved, and it is possible to improve reliability of the radar data acquired by the radar.

A radar according to a second aspect of the present disclosure is mounted on a vehicle lamp and configured to acquire radar data indicating a surrounding environment of a vehicle.

The radar includes:

a radar housing;

a radome that covers an opening of the radar housing;

a circuit board disposed in space formed by the radar housing and the radome;

an antenna portion disposed on the circuit board and including a transmission antenna configured to transmit a radio wave to an outside and a reception antenna configured to receive a reflected radio wave reflected by an object; and

a communication circuit portion disposed on the circuit board and electrically connected to the antenna portion.

The radome includes a dielectric lens that faces the antenna portion and is configured to allow the radio wave transmitted from the transmission antenna and the reflected radio wave to pass therethrough.

The dielectric lens is configured to narrow a spread angle of the radio wave emitted from the transmission antenna.

According to the above configuration, the radome constituting the radar includes the dielectric lens. Further, the dielectric lens faces the antenna portion, and is configured to allow the radio wave transmitted from the transmission antenna and the reflected radio wave to pass therethrough. Further, the dielectric lens can narrow spread angles in a horizontal direction and a vertical direction of the radio wave emitted from the transmission antenna.

In this way, since the spread angle in the vertical direction of the radio wave is narrowed by the dielectric lens, it is possible to reduce the number of antenna elements arranged in the vertical direction. Therefore, it is possible to reduce a size of the radar, and thus it is possible to improve a degree of freedom in design of the vehicle lamp on which the radar is mounted.

In addition, since the spread angle in the horizontal direction of the radio wave is narrowed by the dielectric lens, for example, the radar data is suitably prevented from being adversely affected by a reflected radio wave reflected by an object existing outside a field of view in the horizontal direction of the radar. In this way, it is possible to improve reliability of the radar data acquired by the radar.

A vehicle lamp according to a third aspect of the present disclosure is mounted on a vehicle, and includes:

a lamp housing;

a lamp cover that covers an opening of the lamp housing; and

an illumination unit disposed in a lamp chamber formed by the lamp housing and the lamp cover.

The illumination unit includes:

a first circuit board;

an antenna portion disposed on the first circuit board and including a transmission antenna configured to transmit a radio wave to an outside and a reception antenna configured to receive a reflected radio wave reflected by an object;

a light source portion disposed on the first circuit board and configured to emit light;

a second circuit board electrically connected to the first circuit board;

a communication circuit portion disposed on the second circuit board and configured to generate radar data indicating a surrounding environment of the vehicle;

a light source drive circuit portion disposed on the second circuit board and configured to drive the light source portion; and

a dielectric lens disposed in front of the first circuit board and configured to allow the radio wave transmitted from the transmission antenna and the reflected radio wave to pass therethrough and allow the light emitted from the light source portion to pass therethrough.

The dielectric lens is configured to narrow a spread angle of the radio wave transmitted from the transmission antenna.

According to the above configuration, since the illumination unit includes the antenna portion and the communication circuit portion, the illumination unit not only emits light but also functions as a radar. Therefore, it is not necessary to separately provide the illumination unit and the radar in the vehicle lamp, and it is not necessary to separately secure space in the lamp chamber of the vehicle lamp in order to dispose the radar in the lamp chamber. In this way, it is possible to improve a degree of freedom in design of the vehicle lamp.

Further, the dielectric lens can narrow spread angles in a horizontal direction and a vertical direction of the radio wave emitted from the antenna portion. In this regard, since the spread angle in the vertical direction of the radio wave is narrowed by the dielectric lens, it is possible to reduce the number of antenna elements arranged in the vertical direction. Therefore, a size of the illumination unit can be reduced. In addition, since the spread angle in the horizontal direction of the radio wave is narrowed by the dielectric lens, for example, the radar data is suitably prevented from being adversely affected by a reflected radio wave reflected by an object existing outside a field of view in the horizontal direction of the illumination unit functioning as the radar. In this way, it is possible to improve reliability of the radar data acquired by the illumination unit.

### Advantageous Effects of Invention

According to the present disclosure, the degree of freedom in design of the vehicle lamp on which the radar is mounted can be improved, and the reliability of the radar data acquired by the radar can be improved.

Further, according to the present disclosure, the degree of freedom in design of the vehicle lamp on which the illumination unit is mounted can be improved, and the reliability of the radar data acquired by the illumination unit can be improved.

### BRIEF DESCRIPTION OF DRAWINGS

FIG. 1 is a front view of a vehicle including a left vehicle lamp and a right vehicle lamp;

FIG. 2 is a horizontal cross-sectional view schematically showing a left vehicle lamp according to a first embodiment;

FIG. 3 shows a specific configuration of a radar;

FIG. 4 is a front view showing an example of an antenna portion of the radar;

FIG. 5 is a front view showing an example of a decorative member that conceals the radar;

FIG. 6 is a vertical cross-sectional view schematically showing a radar according to a second embodiment;

FIG. 7 is a vertical cross-sectional view schematically showing a left vehicle lamp according to a third embodiment; and

FIG. 8 is a front view showing an example of a first circuit board.

### DESCRIPTION OF EMBODIMENTS

### First Embodiment

Hereinafter, a first embodiment of the present disclosure will be described with reference to the drawings. Dimensions of members shown in the drawings may be different from actual dimensions of the respective members for convenience of description.

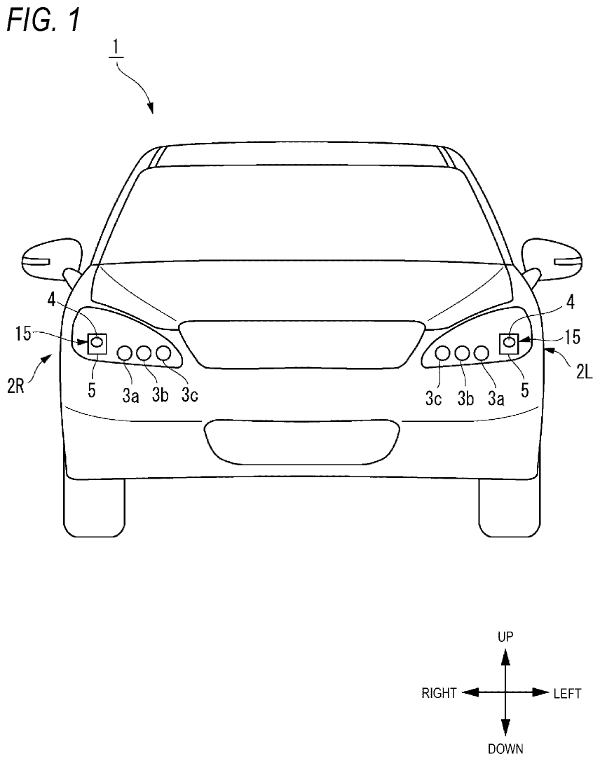

In the description of the present embodiment, for convenience of description, a “left-right direction”, an “up-down direction”, and a “front-rear direction” may be referred to as appropriate. These directions are relative directions set for a vehicle 1 shown in FIG. 1. Here, the “left-right direction” is a direction including a “leftward direction” and a “rightward direction”. The “up-down direction” is a direction including an “upward direction” and a “downward direction”. The “front-rear direction” is a direction including a “forward direction” and a “rearward direction”. Although the “front-rear direction” is not shown in FIG. 1, the “front-rear direction” is a direction perpendicular to the left-right direction and the up-down direction.

In the present embodiment, it is assumed that directions set for a right vehicle lamp 2R and a left vehicle lamp 2L coincide with the directions set for the vehicle 1.

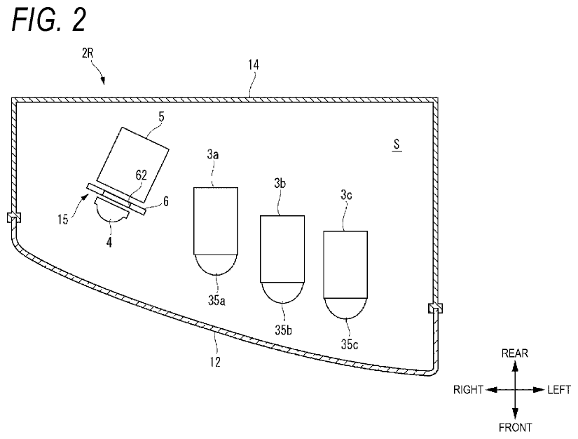

Further, in the description of the present embodiment, a “vertical direction” and a “horizontal direction” may be referred to as appropriate. These directions are relative directions set for a radar 5 shown in FIG. 2. The vertical direction of the radar 5 coincides with the up-down direction of the vehicle 1. The horizontal direction of the radar 5 is a direction orthogonal to the vertical direction of the radar 5.

First, the vehicle 1 according to the present embodiment will be described with reference to FIG. 1. FIG. 1 is a front view of the vehicle 1 that includes the left vehicle lamp 2L and the right vehicle lamp 2R. As shown in FIG. 1, the left vehicle lamp 2L is disposed on a left front side of the vehicle 1, and the right vehicle lamp 2R is disposed on a right front side of the vehicle 1. Each of the left vehicle lamp 2L and the right vehicle lamp 2R includes a radar unit 15, an illumination unit 3a, an illumination unit 3b, and an illumination unit 3c. In the present embodiment, the left vehicle lamp 2L and the right vehicle lamp 2R have the same configuration. Therefore, in the following description, a specific configuration of the right vehicle lamp 2R will be described with reference to FIG. 2.

For convenience of description, the left vehicle lamp 2L and the right vehicle lamp 2R may be collectively and simply referred to as the “vehicle lamp 2”. In addition, although the vehicle lamp 2 that functions as a headlamp is described in the present embodiment, the vehicle lamp 2 may be a rear lamp that is disposed on a rear surface of the vehicle 1 and mounted with the radar unit 15 and one or more illumination units.

FIG. 2 is a horizontal cross-sectional view schematically showing the right vehicle lamp 2R. As shown in FIG. 2, the right vehicle lamp 2R includes a lamp housing 14, a lamp cover 12 that covers an opening of the lamp housing 14, and three illumination units, namely the illumination unit 3a, the illumination unit 3b, and the illumination unit 3c, and the radar unit 15.

The illumination unit 3a, the illumination unit 3b, and the illumination unit 3c are disposed in a lamp chamber S formed by the lamp housing 14 and the lamp cover 12. Each of the illumination unit 3a, the illumination unit 3b, and the illumination unit 3c is configured to emit a light distribution pattern toward the front of the vehicle 1. For example, two of the illumination unit 3a, the illumination unit 3b, and the illumination unit 3c may be configured to emit a low-beam light distribution pattern, and one of the illumination unit 3a, the illumination unit 3b, and the illumination unit 3c may be configured to emit a high-beam light distribution pattern.

In addition, the illumination unit 3a includes a light source (not shown) configured to emit light and a projection lens 35a configured to allow the light emitted from the light source to pass therethrough. The illumination unit 3b includes a light source (not shown) and a projection lens 35b configured to allow the light emitted from the light source to pass therethrough. The illumination unit 3c includes a light source (not shown) and a projection lens 35c configured to allow the light emitted from the light source to pass therethrough. Each of the projection lens 35a, the projection lens 35b, and the projection lens 35c is configured as a plano-convex lens.

The radar unit 15 includes the radar 5, a dielectric lens 4, and a decorative member 6. The radar 5 is disposed in the lamp chamber S, and is configured to acquire radar data indicating a surrounding environment of the vehicle 1 by emitting radio waves (for example, millimeter waves or microwaves) to the outside of the vehicle 1. In the present embodiment, the radar 5 is configured to acquire radar data indicating a front region of the vehicle 1 by emitting radio waves toward the front of the vehicle 1. The radar 5 is, for example, a millimeter wave radar or a microwave radar.

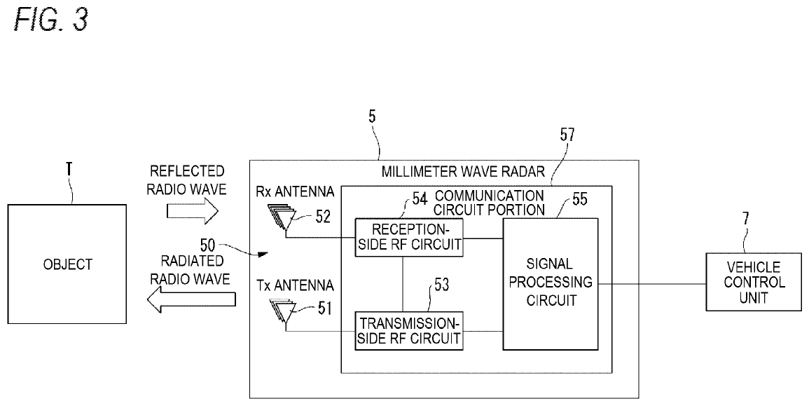

Next, a specific configuration of the radar 5 will be described below with reference to FIG. 3. FIG. 3 shows the specific configuration of the radar 5. As shown in FIG. 3, the radar 5 includes an antenna portion 50 and a communication circuit portion 57. The antenna portion 50 includes a transmission antenna 51 and a reception antenna 52. The transmission antenna 51 is configured to radiate a radio wave (for example, a millimeter wave having a wavelength of 1 mm to 10 mm) to the outside of the vehicle 1. The reception antenna 52 is configured to receive a reflected radio wave reflected by an object T (for example, another vehicle) existing outside the vehicle 1. The radiated radio wave radiated from the transmission antenna 51 is reflected by the object T, and then the reflected radio wave from the object T is received by the reception antenna 52. In this way, information on the object T existing outside the vehicle 1 is acquired based on a high frequency signal input to the transmission antenna 51 and a high frequency signal output from the reception antenna 52.

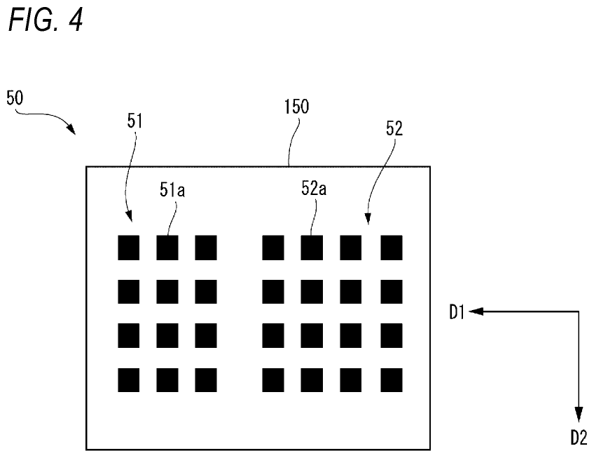

Each of the transmission antenna 51 and the reception antenna 52 may be configured as a patch antenna. In this regard, as shown in FIG. 4, the antenna portion 50 further includes an antenna board 150. The transmission antenna 51 is constituted by a plurality of metal patterns 51a (antenna elements) formed on the antenna board 150. The plurality of metal patterns 51a are arranged in a matrix of 4 rows×3 columns on the antenna board 150. That is, three metal patterns 51a are arranged in a D1 direction, and four metal patterns 51a are arranged in a D2 direction. Here, the D1 direction and the D2 direction are orthogonal to each other. The D2 direction corresponds to the vertical direction of the radar 5, and the D1 direction corresponds to the horizontal direction of the radar 5.

The reception antenna 52 may be constituted by a plurality of metal patterns 52a (antenna elements) formed on the antenna board 150. The plurality of metal patterns 52a are arranged in a matrix of 4 rows×4 columns on the antenna board 150. That is, four metal patterns 52a are arranged in the D1 direction, and four metal patterns 52a are arranged in the D2 direction.

Next, as shown in FIG. 3, the communication circuit portion 57 includes a transmission-side radio frequency (RF) circuit 53, a reception-side RF circuit 54, and a signal processing circuit 55. The communication circuit portion 57 is configured as a monolithic microwave integrated circuit (MMIC). The transmission-side RF circuit 53 is electrically connected to the transmission antenna 51, and is configured to input a high-frequency signal (TX signal) to the transmission antenna 51. When the radar 5 is a millimeter wave radar employing a frequency modulated continuous wave (FMCW) method, the transmission-side RF circuit 53 generates a chirp signal (FMCW signal) whose frequency changes linearly over time.

The reception-side RF circuit 54 is electrically connected to the reception antenna 52, and is configured to receive a high-frequency signal (RX signal) from the reception antenna 52 and receive a TX signal from the transmission-side RF circuit. The reception-side RF circuit 54 is configured to generate an intermediate frequency (IF) signal (also referred to as a beat frequency signal) based on the TX signal and the RX signal, and then convert the IF signal into a digital signal.

The signal processing circuit 55 is configured to control the transmission-side RF circuit 53 and the reception-side RF circuit 54 in accordance with a control signal from a vehicle control unit 7. Further, the signal processing circuit 55 is configured to generate radar data indicating the surrounding environment of the vehicle 1 by processing the digital signal output from the reception-side RF circuit 54, and then transmit the generated radar data to the vehicle control unit 7. The signal processing circuit 55 includes, for example, a digital signal processor (DSP) and a microcomputer including a processor and a memory.

The vehicle control unit 7 (in-vehicle computer) specifies the surrounding environment of the vehicle 1 (in particular, information on the object T) based on the radar data output from the radar 5, and then controls traveling of the vehicle 1. The vehicle control unit 7 may control the traveling of the vehicle 1 based on the radar data, image data acquired from a camera (not shown), and point cloud data acquired from a LiDAR unit (not shown).

Referring back to FIG. 2, the dielectric lens 4 of the radar unit 15 is disposed in front of the radar 5, and is configured to allow the radio wave emitted from the radar 5 to pass therethrough. The dielectric lens 4 is configured to narrow a spread angle of the radio wave emitted from the radar 5. In this regard, the dielectric lens 4 can narrow a spread angle θ in the horizontal direction of the radio wave from about 180 degrees to about 110 degrees, and can narrow the spread angle θ in the vertical direction of the radio wave from about 100 degrees to about 20 degrees. Further, the dielectric lens 4 may be configured to convert the radio wave, which is a spherical wave emitted from the radar 5, into a plane wave.

In addition, the dielectric lens 4 is configured as a plano-convex lens. In the present embodiment, since the dielectric lens 4, the projection lens 35a, the projection lens 35b, and the projection lens 35c of the illumination unit 3a, the illumination unit 3b, and the illumination unit 3c are configured as plano-convex lenses, appearance of the radar unit 15 constituted by the radar 5 and the dielectric lens 4 is similar to appearance of the illumination unit 3a, the illumination unit 3b, and the illumination unit 3c. In this way, since appearance of constituent elements mounted on the right vehicle lamp 2R can be unified, design of appearance of the right vehicle lamp 2R can be improved.

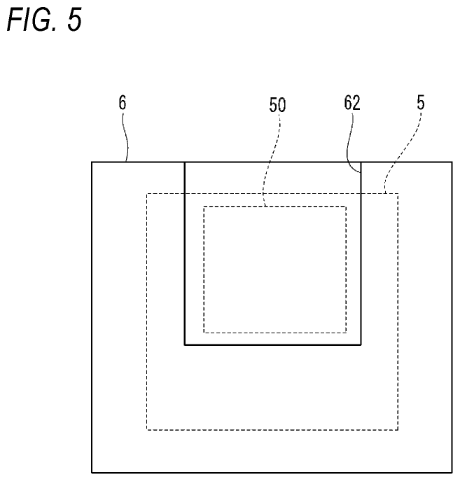

The decorative member 6 is disposed between the dielectric lens 4 and the radar 5, and functions to conceal the radar 5 from the outside of the vehicle 1. The decorative member 6 is formed of, for example, an opaque resin material. In addition, as shown in FIG. 5, the decorative member 6 includes an opening 62 through which the antenna portion 50 of the radar 5 is exposed. As described above, since the decorative member 6 exposes the antenna portion 50 of the radar 5 and conceals a portion other than the antenna portion 50 of the radar 5 from the outside of the vehicle 1, it is possible to further improve design of appearance of the left vehicle lamp 2L.

According to the present embodiment, the spread angles θ in the horizontal direction and the vertical direction of the radio wave emitted from the radar 5 can be narrowed by the dielectric lens 4 disposed in front of the radar 5. In this way, since the spread angle θ in the vertical direction of the radio wave is narrowed by the dielectric lens 4, it is possible to reduce the number of metal patterns 51a and 52a arranged in the vertical direction (D2 direction) (see FIG. 4). Therefore, a size of the antenna portion 50 of the radar 5 can be reduced, and thus a degree of freedom in design of the vehicle lamp 2 on which the radar 5 is mounted can be improved.

In addition, since the spread angle θ in the horizontal direction of the radio wave is narrowed by the dielectric lens 4, the radar data is suitably prevented from being adversely affected by a reflected radio wave reflected by an object existing outside a field of view (detection region) in the horizontal direction of the radar 5. In this way, it is possible to improve reliability of the radar data acquired by the radar 5.

### Second Embodiment

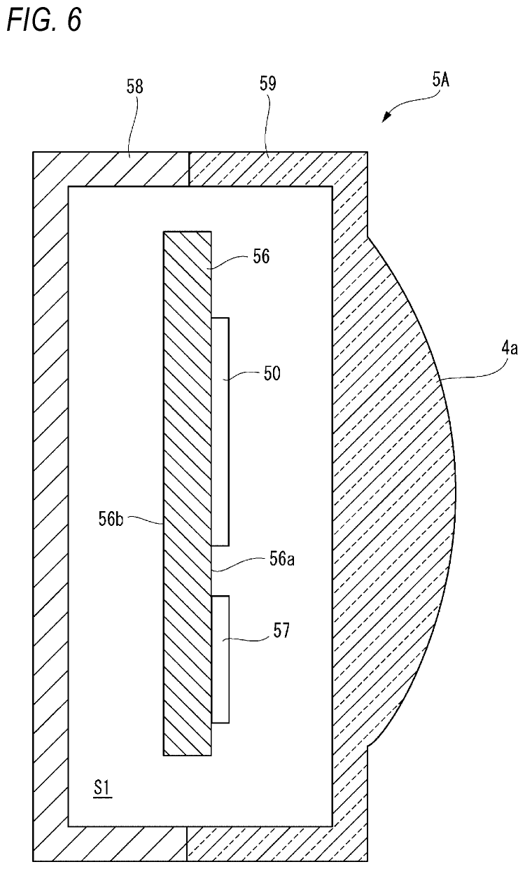

Next, a second embodiment of the present disclosure will be described below with reference to FIG. 6. FIG. 6 is a vertical cross-sectional view schematically showing a radar 5A according to the second embodiment. In the first embodiment, the radar 5 and the dielectric lens 4 are separated from each other, whereas in the second embodiment, a radome 59 of the radar 5A includes a dielectric lens 4a. In this regard, the second embodiment is largely different from the first embodiment. In the following description, constituent elements having the same reference numerals as those of the constituent elements already described in the first embodiment will not be repeatedly described. In addition, the constituent elements described in the first embodiment will be referred to as appropriate.

As shown in FIG. 6, the radar 5A is mounted on the left vehicle lamp 2L and the right vehicle lamp 2R shown in FIG. 1, and is configured to acquire the radar data indicating the surrounding environment of the vehicle 1. The radar 5A includes a radar housing 58, the radome 59, a circuit board 56, the antenna portion 50, and the communication circuit portion 57.

The radome 59 is arranged to cover an opening of the radar housing 58. Space 51 is formed by the radar housing 58 and the radome 59. The radome 59 faces the antenna portion 50 and is configured to allow a radio wave emitted from the antenna portion 50 to pass therethrough. The radome 59 includes the dielectric lens 4a. The dielectric lens 4a faces the antenna portion 50. The dielectric lens 4a is configured to allow a radio wave transmitted from the transmission antenna 51 (see FIG. 3) of the antenna portion 50 to pass therethrough and allow a reflected radio waves reflected by an object existing outside the radar 5A to pass therethrough.

The dielectric lens 4a is configured to narrow a spread angle of the radio wave emitted from the transmission antenna 51. In this regard, the dielectric lens 4a can narrow the spread angle θ in the horizontal direction of the radio wave from about 180 degrees to about 110 degrees, and can narrow the spread angle θ in the vertical direction of the radio wave from about 100 degrees to about 20 degrees. Further, the dielectric lens 4a may be configured to convert the radio wave, which is a spherical wave emitted from the transmission antenna 51, into a plane wave. In addition, the dielectric lens 4a is configured as a plano-convex lens.

The circuit board 56 is disposed in the space 51 and includes a first surface 56a and a second surface 56b located on a side opposite to the first surface 56a. The antenna portion 50 is disposed on the first surface 56a of the circuit board 56, and includes the transmission antenna 51, the reception antenna 52, and the antenna board 150 (see FIG. 4). The communication circuit portion 57 includes the transmission-side RF circuit 53, the reception-side RF circuit 54, and the signal processing circuit 55 (see FIG. 3).

According to the present embodiment, the radome 59 constituting the radar 5A includes the dielectric lens 4a. Further, the dielectric lens 4a faces the antenna portion 50, and is configured to allow the radio wave transmitted from the transmission antenna 51 of the antenna portion 50 and the reflected radio wave reflected by the object to pass therethrough. Further, the dielectric lens 4a can narrow the spread angles in the horizontal direction and the vertical direction of the radio wave emitted from the transmission antenna 51.

In this way, since the spread angle in the vertical direction of the radio wave is narrowed by the dielectric lens 4a, it is possible to reduce the number of metal patterns 51a and 52a arranged in the vertical direction (D2 direction) (see FIG. 4). Therefore, it is possible to reduce a size of the radar 5A, and thus it is possible to improve a degree of freedom in design of the vehicle lamp 2 on which the radar 5A is mounted.

In addition, since the spread angle in the horizontal direction of the radio wave is narrowed by the dielectric lens 4a, for example, the radar data is suitably prevented from being adversely affected by a reflected radio wave reflected by an object existing outside a field of view in the horizontal direction of the radar 5A. In this way, it is possible to improve reliability of the radar data acquired by the radar 5A.

### Third Embodiment

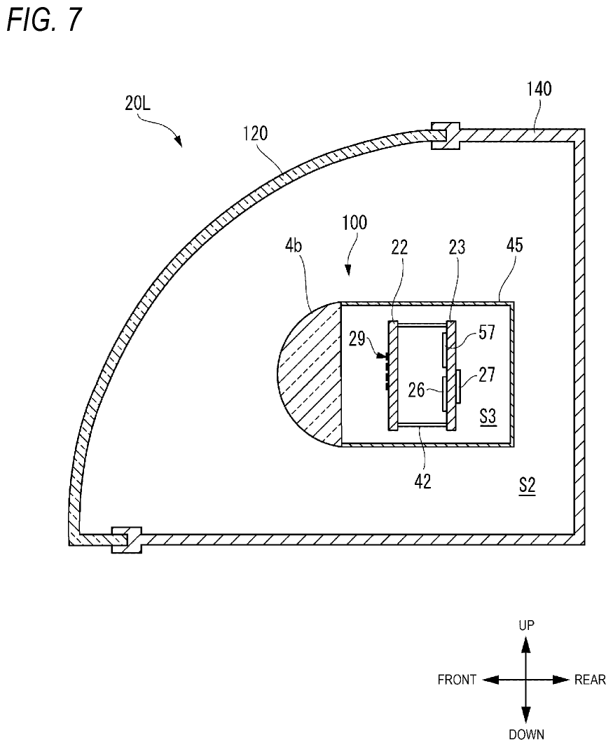

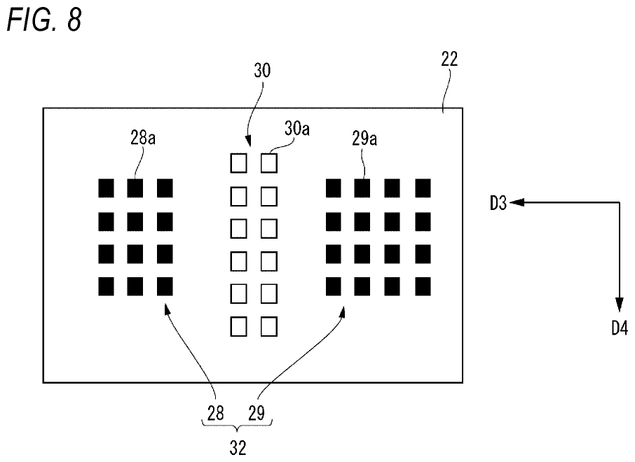

Next, a third embodiment of the present disclosure will be described below with reference to FIGS. 7 and 8. FIG. 7 is a vertical cross-sectional view schematically showing a left vehicle lamp 20L according to the third embodiment. FIG. 8 is a front view showing an example of a first circuit board 22.

As shown in FIG. 7, the left vehicle lamp 20L is mounted on a front surface of a vehicle (not shown), and includes a lamp housing 140, a lamp cover 120 that covers an opening of the lamp housing 140, and an illumination unit 100. The illumination unit 100 is disposed in a lamp chamber S2 formed by the lamp housing 140 and the lamp cover 120. The illumination unit 100 according to the present embodiment functions as a radar and is configured to emit a light distribution pattern (a low-beam light distribution pattern and/or a high-beam light distribution pattern) to the outside of the vehicle.

As shown in FIGS. 7 and 8, the illumination unit 100 includes the first circuit board 22, an antenna portion 32, a light source portion 30, a second circuit board 23, the communication circuit portion 57, a light source drive circuit portion 26, and a power supply circuit portion 27. The illumination unit 100 further includes a housing 45 and a dielectric lens 4b.

As shown in FIG. 8, the first circuit board 22 is configured to be mounted with the antenna portion 32 and the light source portion 30. The antenna portion 32 includes a transmission antenna 28 and a reception antenna 29. The transmission antenna 28 is configured to transmit a radio wave (for example, a millimeter wave having a wavelength of 1 mm to 10 mm) to the outside. The reception antenna 29 is configured to receive a reflected radio wave reflected by an object such as another vehicle existing outside the vehicle.

Each of the transmission antenna 28 and the reception antenna 29 is configured as a patch antenna. The transmission antenna 28 is constituted by a plurality of metal patterns 28a (antenna elements) formed on the first circuit board 22. The plurality of metal patterns 28a are arranged in a matrix of 4 rows×3 columns on the first circuit board 22. That is, three metal patterns 28a are arranged in a D3 direction, and four metal patterns 28a are arranged in a D4 direction. Here, the D3 direction and the D4 direction are orthogonal to each other. The D4 direction corresponds to the vertical direction of the illumination unit 100, and the D3 direction corresponds to the horizontal direction of the illumination unit 100.

The reception antenna 29 may be constituted by a plurality of metal patterns 29a (antenna elements) formed on the first circuit board 22. The plurality of metal patterns 29a are arranged in a matrix of 4 rows×4 columns on the first circuit board 22. That is, four metal patterns 29a are arranged in the D3 direction, and four metal patterns 29a are arranged in the D4 direction.

The light source portion 30 is configured to form a light distribution pattern by emitting light to the outside. The light source portion 30 is disposed between the transmission antenna 28 and the reception antenna 29, and includes a plurality of semiconductor light emitting elements 30a disposed on the first circuit board 22. Each semiconductor light emitting element 30a is, for example, a light emitting diode (LED) or a laser diode (LD).

The plurality of semiconductor light emitting elements 30a are arranged in a matrix of 6 rows×2 columns on the first circuit board 22. That is, two semiconductor light emitting elements 30a are arranged in the D3 direction, and six semiconductor light emitting elements 30a are arranged in the D4 direction. Each semiconductor light emitting element 30a is independently lighted or extinguished. In this way, by individually controlling the lighting/extinguishing of each semiconductor light emitting element 30a, it is possible to emit a desired light distribution pattern from the light source portion 30.

The second circuit board 23 is electrically connected to the first circuit board 22 via an electrical connector 42. The communication circuit portion 57 and the light source drive circuit portion 26 are disposed on one surface of the second circuit board 23, while the power supply circuit portion 27 is disposed on the other surface of the second circuit board 23.

The communication circuit portion 57 is configured to generate radar data indicating a surrounding environment of the vehicle. As shown in FIG. 3, the communication circuit portion 57 includes the transmission-side RF circuit 53, the reception-side RF circuit 54, and the signal processing circuit 55. The transmission-side RF circuit 53 is electrically connected to the transmission antenna 28, and the reception-side RF circuit 54 is electrically connected to the reception antenna 29.

The light source drive circuit portion 26 is electrically connected to the light source portion 30 and is configured to drive the light source portion 30. The light source drive circuit portion 26 is configured to supply a lighting control signal (for example, a PWM signal) to each of the semiconductor light emitting elements 30a of the light source portion 30. The power supply circuit portion 27 is configured to control power to be supplied to the communication circuit portion 57 and the light source drive circuit portion 26.

The housing 45 is configured to accommodate the first circuit board 22 and the second circuit board 23. In this regard, the first circuit board 22 and the second circuit board 23 are disposed in space S3 formed by the housing 45 and the dielectric lens 4b.

The dielectric lens 4b is configured as a plano-convex lens, and is disposed in front of the first circuit board 22. The dielectric lens 4b is configured to allow the radio wave transmitted from the transmission antenna 28 to pass therethrough and allow the reflected radio wave reflected by the object existing outside the vehicle to pass therethrough.

The dielectric lens 4b is configured to narrow a spread angle of the radio wave emitted from the transmission antenna 28. In this regard, the dielectric lens 4b can narrow the spread angle θ in the horizontal direction of the radio wave from about 180 degrees to about 110 degrees, and can narrow the spread angle θ in the vertical direction of the radio wave from about 100 degrees to about 20 degrees. Further, the dielectric lens 4b may be configured to convert the radio wave, which is a spherical wave emitted from the transmission antenna 28, into a plane wave.

In addition, the dielectric lens 4b is configured to allow the light emitted from the light source portion 30 to pass therethrough. In this regard, the dielectric lens 4b is configured to project the light emitted from the light source portion 30 to the front of the left vehicle lamp 20L. In this way, the dielectric lens 4b functions as an omnidirectional dielectric lens applicable to both light and radio waves.

According to the present embodiment, since the illumination unit 100 includes the antenna portion 32 and the communication circuit portion 57, the illumination unit 100 not only emits light but also functions as a radar. Therefore, it is not necessary to separately provide the illumination unit and the radar in the vehicle lamp, and it is not necessary to separately secure space in the left vehicle lamp 20L in order to dispose the radar in the lamp chamber S2. In this way, it is possible to improve a degree of freedom in design of the left vehicle lamp 20L.

Further, the dielectric lens 4b can narrow the spread angles θ in the horizontal direction and the vertical direction of the radio wave emitted from the antenna portion 32. In this regard, since the spread angle θ in the vertical direction of the radio wave is narrowed by the dielectric lens 4b, it is possible to reduce the number of metal patterns 28a and 29a (antenna elements) arranged in the vertical direction (D4 direction). Therefore, a size of the illumination unit 100 in the vertical direction can be reduced. In addition, since the spread angle θ in the horizontal direction of the radio wave is narrowed by the dielectric lens 4b, for example, the radar data is suitably prevented from being adversely affected by a reflected radio wave reflected by an object existing outside a field of view in the horizontal direction of the illumination unit 100 functioning as the radar. In this way, it is possible to improve reliability of the radar data acquired by the reception antenna 29 of the illumination unit 100.

Although the embodiments of the present disclosure have been described above, the technical scope of the present disclosure should not be construed as being limited by the description of the embodiments. It is to be understood by those skilled in the art that the present embodiments are merely examples, and various modifications of the embodiments are possible within the scope of the invention described in the claims. The technical scope of the present invention should be determined based on the scope of the invention described in the claims and the scope of equivalents thereof.

For example, the number of illumination units described in the first embodiment is not particularly limited. In addition, the number of metal patterns constituting the transmission antenna or the reception antenna is not particularly limited. In addition, although the dielectric lens is configured as a plano-convex lens in the description of the present embodiment, a shape of the dielectric lens is not particularly limited.

The present application appropriately incorporates the contents disclosed in Japanese Patent Application No. 2019-206319 filed on Nov. 14, 2019.

1. A vehicle lamp mounted on a vehicle, comprising:
a lamp housing;
a lamp cover that covers an opening of the lamp housing;
at least one illumination unit disposed in a lamp chamber formed by the lamp housing and the lamp cover;
a radar disposed in the lamp chamber and configured to acquire radar data indicating a surrounding environment of the vehicle by emitting a radio wave to an outside of the vehicle; and
a dielectric lens disposed in front of the radar and configured to allow the radio wave emitted from the radar to pass therethrough,
wherein the dielectric lens is configured to narrow a spread angle of the radio wave emitted from the radar.

2. The vehicle lamp according to claim 1, wherein
the at least one illumination unit includes a light source and a projection lens configured to allow light emitted from the light source to pass therethrough, and
the dielectric lens and the projection lens are configured as plano-convex lenses.

3. The vehicle lamp according to claim 1, further comprising: a decorative member disposed between the radar and the dielectric lens so as to conceal a portion other than an antenna portion of the radar from the outside of the vehicle.

4. A radar mounted on a vehicle lamp and configured to acquire radar data indicating a surrounding environment of a vehicle, the radar comprising:
a radar housing;
a radome that covers an opening of the radar housing;
a circuit board disposed in space formed by the radar housing and the radome;
an antenna portion disposed on the circuit board and including a transmission antenna configured to transmit a radio wave to an outside and a reception antenna configured to receive a reflected radio wave reflected by an object; and
a communication circuit portion disposed on the circuit board and electrically connected to the antenna portion, wherein
the radome includes a dielectric lens that faces the antenna portion and is configured to allow the radio wave transmitted from the transmission antenna and the reflected radio wave to pass therethrough, and
the dielectric lens is configured to narrow a spread angle of the radio wave emitted from the transmission antenna.

5. A vehicle lamp comprising: the radar according to claim 4.

6. A vehicle lamp mounted on a vehicle, comprising:
a lamp housing;
a lamp cover that covers an opening of the lamp housing; and
an illumination unit disposed in a lamp chamber formed by the lamp housing and the lamp cover, wherein
the illumination unit includes:
a first circuit board;
an antenna portion disposed on the first circuit board and including a transmission antenna configured to transmit a radio wave to an outside and a reception antenna configured to receive a reflected radio wave reflected by an object;
a light source portion disposed on the first circuit board and configured to emit light;
a second circuit board electrically connected to the first circuit board;
a communication circuit portion disposed on the second circuit board and configured to generate radar data indicating a surrounding environment of the vehicle;
a light source drive circuit portion disposed on the second circuit board and configured to drive the light source portion; and
a dielectric lens disposed in front of the first circuit board and configured to allow the radio wave transmitted from the transmission antenna and the reflected radio wave to pass therethrough and allow the light emitted from the light source portion to pass therethrough, and
the dielectric lens is configured to narrow a spread angle of the radio wave transmitted from the transmission antenna.

7. The vehicle lamp according to claim 6, wherein the light source portion includes a plurality of semiconductor light emitting elements arranged in a predetermined direction.

8. A vehicle comprising:
the vehicle lamp according to claim 1.
